(19) United States
(12) Patent Application Publication
(10) Pub. No.: US 2005/0068544 A1
(43) Pub. Date: Mar. 31, 2005

(54) Panoramic scanner

(76) Inventors: Gunter Doemens, Holzkirchen (DE); Frank Forster, Munchen (DE); Torsten Niederdrank, Erlangen (DE); Peter Rummel, Gmund (DE)

Correspondence Address: SCHIFF HARDIN, LLP;PATENT DEPARTMENT, 6600 SEARS TOWER, CHICAGO, IL, 60606-6473, US

(21) Appl. No.: 10/950,219

(22) Filed: Sep. 24, 2004

Related U.S. Application Data
(60) Provisional application No. 60/505,911, filed on Sep. 25, 2003.

(30) Foreign Application Priority Data
Sep. 25, 2003 (DE) 103 44 922.1

(51) Int. Cl. G01B 11/24

(52) U.S. Cl. 356/601

(57) ABSTRACT

A cost-effective panoramic scanner provides for the three-dimensional detection of objects, and in particular for the detection of ear impressions. For this purpose, a pattern is projected onto an object to be detected via a projector that generates an object image via a camera, the object image containing images of markings that enable an unambiguous assignment of the position of the object with respect to the projector and the camera. Since an exact synchronization of the rotary movement of the object with the recording of the object images is not necessary by virtue of the markings, the precision of the mechanism used is relatively nonstringent.

### CROSS-REFERENCE TO RELATED APPLICATIONS

The present application claims the benefit of U.S. Provisional Application No. 60/505,911, filed Sep. 25, 2003, herein incorporated by reference.

### BACKGROUND OF THE INVENTION

The invention relates to a method for the three-dimensional detection of an object. Furthermore, the invention relates to an apparatus for performing the method and a use of the apparatus and the method.

Methods for the three-dimensional detection and digitization of objects are used for various application purposes, e.g., in the development, production and quality control of industrial products and components. In medical technology, use is made of, for example, optical measurement methods for producing the housings of hearing aids that can be worn in the ear.

For the purpose of individually adapting a housing to the auditory canal of a person wearing a hearing aid, impressions of the patient's outer auditory canal are created by an audiologist by way of a rubber-like plastics composition. In order to be able to employ stereolithographic or similar methods for producing the housings, it is necessary to create three-dimensional computer models from the ear impressions. This procedure has previously been effected by the hearing aid manufacturer, where the impressions are measured panoramically three-dimensionally by way of a precision scanner, and a 3D computer model of the outer auditory canal is created on the basis of these data. Afterwards, in a laser sintering process, the individually formed housing shell is produced on the basis of the data of the computer model.

The precision scanners used are usually designed as laser scanners in which a laser beam is guided over the surface of the impression in a controlled manner and the backscattered light is observed by a detector (e.g., a CCD camera) from a direction deviating from the laser beam. The surface coordinates of the impression are then calculated by triangulation. In the case of the known laser scanner VIVID 910 from the company Minolta, a line is generated from the laser beam and is moved over the surface of the object to be detected, e.g., an ear impression. The image of the line is in turn observed by a camera, the surface coordinates of the object to be detected being deduced from the deformation of the line image by triangulation. A rotary stage controller on which the object rotates through 360° during the scanning serves as an accessory to the known laser scanner.

What is disadvantageous about the known laser scanners is their high procurement costs, which are occasionally also caused by the high-precision mechanism of the rotary stage controllers.

Frank Forster, Manfred Lang, Bernd Radig in “Real-Time Range Imaging for Dynamic Scenes Using Color-Edge Based Structured Light”, ICPR '02, Vol. 3, pp. 30645-30648, 2002, disclose a method for the 3D detection of an object by way of structured light. In this case, a projector is used to project a color pattern containing a redundant code with known projection data onto the surface of an object, and the object with the color pattern projected thereon is recorded by a camera from a direction deviating from the projection direction. By decoding the color pattern at each pixel of the camera image, it is possible to determine the associated three-dimensional coordinates of the object surface by way of triangulation. This method permits the reconstruction of a partial region of the surface of the object with a video image.

Japanese Patent Document No. JP 2001108421 A discloses a 3D scanner for the three-dimensional detection of an object. During scanning, the object rotates together with a reference object on which markings are provided. Thus, different views of the object and of the reference object are photographed, the photographs being combined to form a three-dimensional computer model on the basis of the markings on the reference object. What is disadvantageous about the known method is (for some applications) the inadequate correspondence between the computer model and the real object.

### SUMMARY

It is an object of the present invention to provide a method and also a panoramic scanner which make it possible to detect three-dimensionally an object, in particular an ear impression, in a comparatively simple and cost-effective manner with the accuracy required for producing a hearing aid housing shell.

This object is achieved by a method for the three-dimensional detection of an object, comprising: providing and object to be detected, a projector and rotator configured for rotating the projector and the camera relative to the object; providing markings with a position relative to the object that remains the same during the rotation; projecting a pattern onto the object to be detected with the projector; recording an object image with the camera, and detecting the image of at least one marking in the object image; repeatedly adjusting the projector and the camera relative to the object with respective projection of the pattern and recording of an object image until a termination criterion is reached; automatically combining the object images or data obtained from the latter on the basis of the images of the markings that are contained in the object images; and creating a three-dimensional object model from the combined object images or data.

This object is also achieved by a panoramic scanner for a three-dimensional detection of an object, comprising: a projector configured for projecting a pattern onto the object to be detected; a camera configured for detecting object images; a rotator configured for rotating the object relative to the projector and the camera having a position relative to the object that remains the same during the rotation, images of the markings being present in the object images, configured so that it is possible to combine object images generated at different angles of rotation of the object relative to the projector and the camera, or data obtained from these object images, based on the images of the markings that are present in the object images, to form a three-dimensional object model.

Various embodiments of the invention are discussed below. The three-dimensional detection of an object utilizes a projector, a camera and mechanism for rotating the projector and the camera relative to the object. The projector projects a two-dimensional pattern, e.g., a color pattern, containing a redundant code with known projection data onto the surface of the object. The color pattern projected on is subsequently recorded by a camera, e.g., a CCD camera, from a direction deviating from the projection direction. By decoding the color pattern at each pixel of the camera image, the associated three-dimensional coordinates of the object surface are determined by way of triangulation.

In order to enable a three-dimensional panoramic view, the object rotates relative to the projector and the camera. For this purpose, the object is preferably situated on a rotary stage controller. The rotary stage controller rotates through a predeterminable angle between two recordings, so that it is possible to record a plurality of object images, e.g., 60, per periphery.

During a scan, the object generally rotates once through 360° about the rotation axis. If only a partial region of an object is to be digitized, then the object may also be rotated through an angle of less than 360°. Furthermore, it is also possible for more than one complete revolution to be performed during the detection of an object in order to increase the accuracy of the 3D model to be generated. By way of example, five completely executed revolutions of the object then constitute a termination criterion for the scan.

In order that a contiguous panoramic view of the object can be generated from these individual images, it is advantageous if the 3D data of the individual images are related to a common coordinate system. For the requisite calibration, in accordance with an embodiment of the invention, markings are provided on the scanner and do not change their position with respect to the object during scanning. With the use of a rotary stage controller, the markings are preferably situated on the rotary stage controller or at the edge of the rotary stage controller. The markings are configured in such a way that a specific number of these markings are visible in each camera image and the angle of rotation of the object relative to the projector and the camera can be gathered from these markings unambiguously and with the required accuracy. In this case, a higher number of markings increases the accuracy of the 3D reconstruction.

In an advantageous manner, the position of the markings that are moved with the object is precisely determined once with respect to a “world coordinate system” and communicated to the evaluation system. It is then possible to determine the relative position of the object with respect to the projector and the camera or the angle of rotation of the rotary stage controller from the position and the coding of the markings recorded in the object image in the coordinate system. Successively recorded individual images or the 3D data records obtained from the latter can then be combined in a simple manner by way of a corresponding coordinate transformation to form the overall view in the “world coordinate system”.

Advantageously, a synchronization of the individual image recordings with the rotary movement of the object is achieved in a simple and cost-effective manner without this requiring a high-precision and correspondingly expensive mechanism. A user of the panoramic scanner does not have to perform any calibration or adjustment operations, with the exception of fixing the object to be measured on the rotary stage controller.

Consequently, what has been created is a possibility for detecting the 3D panoramic surface of an object, this possibility being simple to control but nevertheless highly precise and cost-effective. The panoramic scanner is therefore e.g., especially suitable for use by an audiologist who creates an ear impression of a patient and digitizes it three-dimensionally by way of the scanner, so that the model data obtained can be communicated directly to the manufacturer of a housing shell by data transmission (E-mail or the like). This saves time and costs in the production of a hearing aid housing.

In one embodiment of the invention, a plurality of overlapping object images are recorded in the course of a revolution of the object relative to the camera and the projector. In this case, a plurality of the same markings are then visible in each case in successive object images. With the aid of the common visible markings, the object images are combined in such a way as to produce an “image composite”. A precise measurement of the markings is not necessary for this purpose, which simplifies the production of the system.

The relative camera coordinates of each recording can be determined by way of a method that is referred to as “cluster compensation” and is known from photogrammetry. A few markings measured in the “world coordinate system” serve for relating the image composite thereto. After this step, the individual object images can then be combined in a simple manner by way of a corresponding coordinate transformation to form the overall view. In order to simplify the calculation, two axes of the “world coordinate system” lie in the plane spanned by the rotary stage controller and the third axis of the “world coordinate system” coincides with the rotation axis of the rotary stage controller.

The markings are preferably configured in such a way that they contain a coding with the extent 1−n, e.g., in the form of a binary code. The markings advantageously contain a few measurement positions (corners, lines, circles or the like). The markings recorded in the object images are automatically detected, decoded and measured in each object image by way of a suitable image processing software. The markings are preferably embodied in such a way that, for each object image, on the basis of the markings contained therein, it is possible to unambiguously assign the spatial position with respect to the camera and the projector.

In one embodiment of the invention, it is provided that the rotation axis about which the object rotates relative to the projector and the camera can be pivoted relative to the projector and the camera. When using a rotary stage controller, the simplest way of achieving this is by tilting the rotary stage controller by a specific angle in at least one direction. This affords advantages in particular in the digitization of ear impressions since the latter may be comparatively fissured. By pivoting the rotation axis, it is possible to prevent shading and thus gaps or inaccuracies in the three-dimensional computer model.

In an advantageous embodiment of the invention, the markings are arranged and configured in such a way that, in addition to the angle of rotation, the angle by which the rotation axis is pivoted with respect to a starting position can also be detected from each object image. In this case, the position of the rotation axis in the preceding object image or an original position may serve as the starting position.

In an alternative embodiment of the invention, at least two cameras arranged offset with respect to one another are present, so that the object can be recorded simultaneously from different viewing angles. The cameras are fitted at a different height with regard to the rotation axis of the object to be detected, so that even undercuts of the object, which would lead to defects in the computer model when using just one camera, can be detected by the further camera. A pivot movement of the rotary stage controller relative to the cameras can thereby be dispensed with. In an advantageous manner, a second projector is also used in addition to a second camera, so that object images are in each case generated by a camera-projector pair.

The self-calibration property of a panoramic scanner has the advantage that all the individual 3D object images can be combined in a simple manner to form a 3D panoramic image. In this case, no stringent requirements are made of the constancy of the rotary movement. A synchronization of the rotary movement with the image recordings is not necessary. It is possible, therefore, to have recourse to a cost-effective mechanism. The accuracy of the 3D detection can easily be increased by increasing the number of images per revolution.

The robustness and accuracy of the measurement rise significantly as a result of a high number of measurement data and in particular as a result of overlapping object images.

### DESCRIPTION OF THE DRAWINGS

The invention is described below on the basis of exemplary embodiments as illustrated in the Figures.

FIG. 1 is an orthogonal diagrammatic sketch of the 3D detection of an object by way of color-coded, structured light;

FIG. 2 is a side view of a scanner according to an embodiment of the invention;

FIG. 3 is an orthogonal perspective view of a scanner according to and embodiment of the invention;

FIG. 4 is an orthogonal view of the scanner in accordance with FIG. 3 with a rotation axis that has been pivoted with respect to FIG. 3;

FIG. 5 is an orthogonal view of the scanner in accordance with FIGS. 3 and 4 with a housing; and

FIG. 6 is an orthogonal view of an alternative embodiment of a scanner with two cameras.

### DETAILED DESCRIPTION OF THE PREFERRED EMBODIMENTS

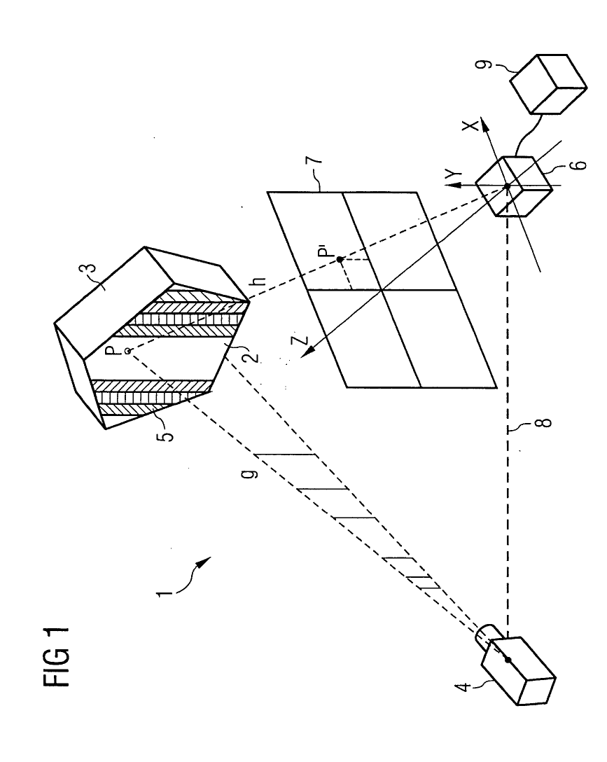

FIG. 1 illustrates an apparatus 1 which serves for determining the three-dimensional object coordinates of a surface 2 of an object 3 to be detected.

The apparatus 1 has a projector 4, which projects a color pattern 5 onto the surface 2 of the object 3 to be detected. In the case illustrated in FIG. 1, the color pattern 5 is composed of a series of color stripes lying next to one another. However, it is also conceivable to use a two-dimensional color pattern instead of the one-dimensional color pattern 5 illustrated in FIG. 1.

In the case of the exemplary embodiment illustrated in FIG. 1, a projection plane g may be assigned to each point P of the surface 2 of the object 3. Consequently, projection data are coded by the color pattern 5. The color pattern 5 projected onto the surface 2 of the object 3 is converted into an image 7 by a camera 6 in that the point P on the surface 2 is transformed into the point P′ in the image 7. Given a known arrangement of the projector 4 and the camera 6, in particular given a known length of a base path 8, the three-dimensional spatial coordinates of the point P on the surface 2 can be calculated by triangulation. The requisite data reduction and evaluation is performed by an evaluation unit 9.

In order to enable the three-dimensional spatial coordinates of the point P on the surface 2 to be determined from an individual image 7 even when the surface 2 of the object 3 has depth jumps and occlusions, the color pattern 5 is constructed in such a way that the coding of the projection planes g is as robust as possible with respect to errors. Furthermore, errors based on the coloration of the object can be eliminated by way of the coding.

In the case of the exemplary embodiments illustrated in FIG. 1, the colors of the color pattern 5 are described by the RGB model. The changes in the color values of the color pattern 5 are effected by changes in the color values in the individual color channels R, G and B.

The color pattern is then intended to satisfy the following conditions:
Only two color values are used in each color channel. In particular, the minimum value and the maximum value are in each case used in each color channel, so that a total of eight colors are available in the RGB model.
Within a code word, each color channel has at least one color change. This condition enables the individual code words to be decoded.
Color elements lying next to one another differ in at least two color channels. This condition serves in particular for ensuring the error tolerance in particular with respect to depth jumps.
The individual code words of the color pattern 5 have a non-trivial Hamming distance. This condition also serves for increasing the error tolerance when decoding the projection planes g.
The color changes are also combined to form code words with a non-trivial hamming distance.

An example is provided below of the color pattern 5 which satisfies the five conditions mentioned above. This color pattern 5 relates to the RGB model with a red color channel R, a green color channel G and a blue color channel B. Since color values in each color channel are only permitted in each case to assume the minimum value and maximum value, a total of eight mixed colors are available, which are respectively assigned the following numbers:

| | |
|---|---|
| Black | 0 |
| Blue | 1 |
| Green | 2 |
| Cyan | 3 |
| Red | 4 |
| Magenta | 5 |
| Yellow | 6 |
| White | 7 |

A length of four color stripes was chosen for the code words of the color values, with overlapping of adjacent code words in each case with three color stripes.

The color changes were also assigned numerical values. Since the color value can remain the same, decrease or increase in each of the three color channels, the result is a total of 27 different color changes of the mixed color, which were respectively assigned a number between 0 and 26. The length of the code words assigned to the color changes was chosen to be equal to three color changes, with overlapping of adjacent code words in each case with two color changes.

A search algorithm found the following series of numbers, which describes an exemplary embodiment of the color pattern 5 which satisfies the five conditions mentioned above:
1243070561217414270342127216534171614361605306 3527170724163052507471470650356036347435061725 24253607

In the exemplary embodiment specified, the first code word comprises the numerals 1243, the second code word comprises the numerals 2430 and the third code word comprises the numerals 4307. The exemplary embodiment shown constitutes a very robust coding.

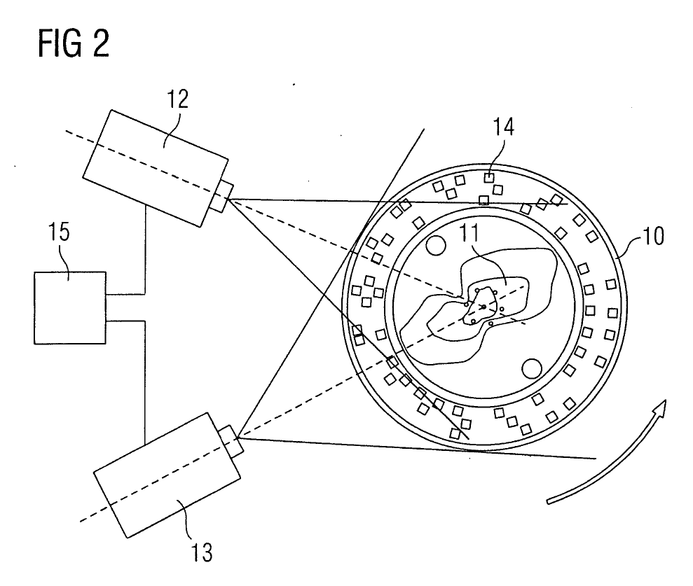

FIG. 2 illustrates the basic diagram of a panoramic scanner according to an embodiment of the invention. The scanner comprises a rotary stage controller 10, which is mounted such that it is rotatable about its axis of symmetry. An ear impression 11 configured according to the individual anatomical characteristics of a person wearing a hearing aid is fixed on the rotary stage controller. The ear impression 11 is intended to be digitized in order to produce an individually formed shell of a hearing aid that can be worn in the ear.

The ear impression is detected by way of coded illumination and triangulation. For this purpose, the panoramic scanner comprises a projector 12, which projects a color-coded pattern onto the surface of the ear impression 11. The color pattern projected onto the surface of the ear impression 11 is converted into an image of the ear impression 11 by a CCD camera 13. By virtue of the rotary movement of the rotary stage controller 10, it is possible to record a multiplicity of such imagings from different observation angles.

In order that the individual imagings can be assigned the respective observation angle, markings 14 are provided at the outer edge of the rotary stage controller 10. In addition to the ear impression 11, a number of these markings 14 are also detected in each image. The images of the markings 14 are automatically detected, decoded and measured in the object images by way of a computer 15 with suitable image processing software. On the basis of the angular information obtained therefrom, a three-dimensional computer model of the ear impression 11 is calculated from the individual imagings. The computer 15 is preferably not part of the actual panoramic scanner, i.e., not arranged with the rotary stage controller 10, the projector 12 and the camera 13 in a common housing. Rather, an external powerful PC with a suitable software may be used as the computer 15. The panoramic scanner then has an interface for connection to the computer 15.

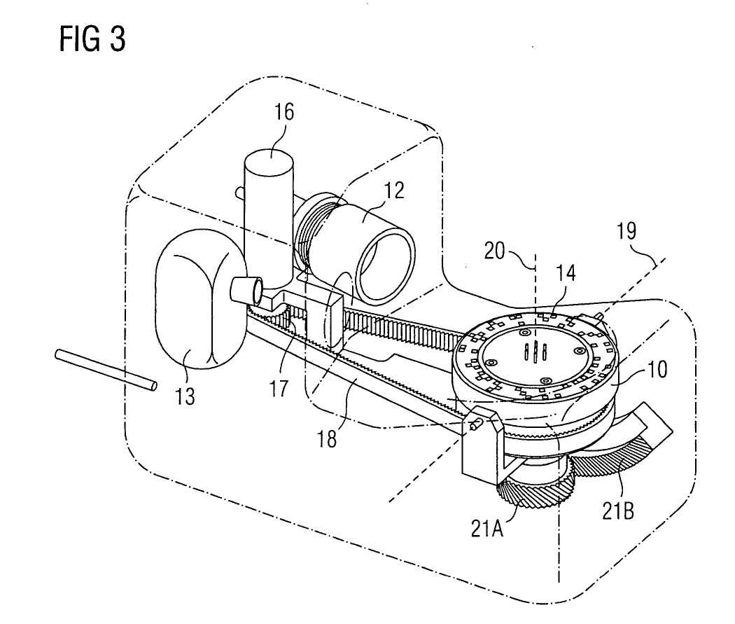

FIG. 3 shows the panoramic scanner illustrated in the basic diagram in FIG. 2, in a perspective view. This also reveals the rotary stage controller 10, a projector 12 and also a CCD camera 13 in the respective position in relation to one another. Furthermore, the drive unit for the rotary stage controller 10 can also be discerned in FIG. 3. This drive unit comprises a motor 16, which drives the rotary stage controller 10 via a gearwheel 17 and a toothed belt 18.

Furthermore, FIG. 3 illustrates a mechanism that enables not only the rotation movement but also a pivot movement in the case of the rotary stage controller 10. In the exemplary embodiment, the pivot axis 19 runs through the point of intersection between the rotation axis 20 and the surface of the rotary stage controller 10. In the exemplary embodiment, the pivot movement is also effected automatically by way of an electric drive, the motor 16 bringing about both the rotation movement and the pivot movement in the case of the embodiment shown.

Specifically, the rotation of the rotary stage controller 10 drives a gearwheel 21A connected thereto, which engages in a toothed piece 21B fixedly anchored in the housing of the scanner and thereby leads to the pivot movement of the drive unit with the motor 16 and the toothed belt 18. The markings 14 provided at the edge of the rotary stage controller 10 can furthermore be seen, which markings make it possible to determine the precise angle of rotation of the rotary stage controller 10 and thus of an object mounted thereon (cf. FIG. 2) with respect to the projector 12 and the camera 13 from the imagings produced.

At the beginning of the detection of an object, the rotation axis is advantageously situated in the starting position envisaged therefor. This may be effected e.g., by a housing cover (not illustrated) being fixed in a pivotable manner to the housing of the panoramic scanner. This housing cover must first be opened before an object is positioned on the rotary stage controller 10. In the course of this housing cover being opened, the entire rotation unit with the motor 16 and the rotary stage controller 10 is then transferred into its starting position by way of a corresponding mechanism (not illustrated).

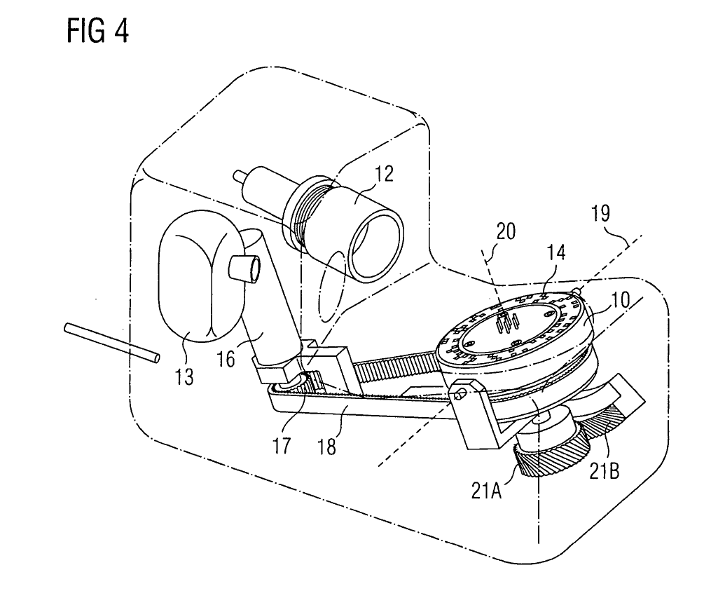

Consequently, at the beginning of a scan, the rotary stage controller 10 is situated in the starting position illustrated in FIG. 3 until it finally assumes the end position shown in FIG. 4 after a plurality of revolutions. The motor 16 is automatically stopped in the end position. On the basis of the markings in the object images, the angle of rotation and the angle by which the rotary stage controller 10 is pivoted from its starting position can be unambiguously gathered from each image. Thus, it is possible to create a 3D model with high accuracy from the individual object images.

As an alternative, the rotary stage controller 10, for execution of the pivot movement, may also be connected to a second motor (not illustrated). The pivot movement may then also be controlled by the computer 15, so that the number of revolutions of the rotary stage controller during which the latter pivots from a starting position into an end position is variable.

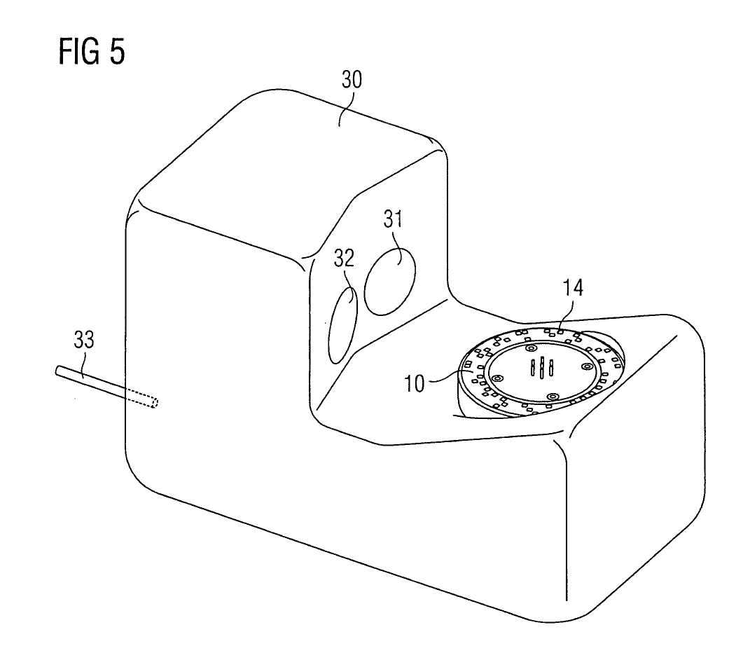

In the case of the panoramic scanner in accordance with FIG. 3, the rotary stage controller, the drive unit of the rotary stage controller, the projector and the camera are accommodated in a common housing 30 illustrated in FIG. 5. The panoramic scanner thereby constitutes a compact unit that is simple to handle. The operational control is also very simple since, besides fixing the examination object on the rotary stage controller 10, the user does not have to carry out any further calibration or adjustment operations. Furthermore, the two housing openings 31 and 32 for the projector and the camera can also be discerned in FIG. 5. Moreover, the panoramic scanner also comprises a cable 33 for connection to a computer.

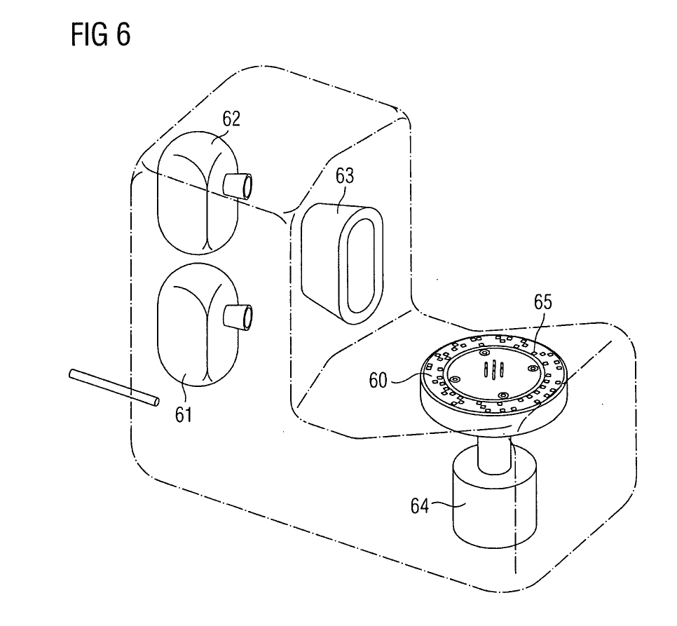

FIG. 6 shows an alternative embodiment of a panoramic scanner according to the invention. In contrast to the previous exemplary embodiments, the rotary stage controller 60 is not pivotable in the case of this embodiment. In order nevertheless to also be able to detect complicated objects with undercuts, the scanner has two cameras 61 and 62 which are arranged one above the other and thus detect the object from different viewing directions.

Furthermore, the projector 63 is not designed as a point radiation source, but rather emits a coded pattern proceeding from a vertically running line. This ensures the projection of the pattern onto all regions of the object that are detected by the cameras. As an alternative, it is also possible to use a plurality of projectors with a point radiation source (not illustrated).

By virtue of the use of a plurality of cameras, a pivot movement of the rotary stage controller 60 becomes invalid and the drive unit can be simplified compared with previous exemplary embodiments. Thus, the rotary stage controller 60 is driven directly (without the interposition of a toothed belt) in the exemplary embodiment in accordance with FIG. 6.

In the case of the panoramic scanner in accordance with FIG. 6, all the components are enclosed by a common housing, so that this scanner also forms a compact unit that is simple to handle. Furthermore, it is possible to have recourse to cost-effective commercially available components (CCD cameras, projector) and in particular to a simple mechanism.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A method for the three-dimensional detection of an object, comprising:
providing and object to be detected, a projector and rotator configured for rotating the projector and the camera relative to the object;
providing markings with a position relative to the object that remains the same during the rotation;
projecting a pattern onto the object to be detected with the projector;
recording an object image with the camera, and detecting the image of at least one marking in the object image;
repeatedly adjusting the projector and the camera relative to the object with respective projection of the pattern and recording of an object image until a termination criterion is reached;
automatically combining the object images or data obtained from the latter on the basis of the images of the markings that are contained in the object images; and
creating a three-dimensional object model from the combined object images or data.

2. The method as claimed in claim 1, further comprising:
assigning a spatial position of the object relative to the projector and the camera in each case to the object images or data obtained from the latter on the basis of the images of the markings that are contained in the object images.

3. The method as claimed in claim 1, further comprising:
determining 2D or 3D data of the object being determined, with respect to a system of coordinates, from the object images.

4. The method as claimed in claim 1, further comprising:
recording a plurality of overlapping object images during a revolution of the object about a rotation axis.

5. The method as claimed in claim 4, wherein images of the same markings are contained in two successive object images.

6. The method as claimed in claim 1, further comprising:
coding the markings.

7. The method as claimed in claim 6, wherein a binary code being used for the coding.

8. The method as claimed in claim 1, wherein the pattern is a structured color pattern.

9. The method as claimed in claim 8, wherein the projection data is coded in the color pattern with the aid of a redundant code.

10. The method as claimed in claim 1, further comprising:
rotating a rotation axis about which the object relative to the projector; and
automatically pivoting the camera relative to the projector and the camera during the detection of the object.

11. The method as claimed in claim 10, further comprising:
performing both a rotation movement and a pivot movement between a recording of successive object images.

12. The method as claimed in claim 10, further comprising:
automatically pivoting a rotary stage controller on which the object is mounted with respect to the projector and the camera for the purpose of pivoting the rotation axis.

13. The method as claimed in claim 10, further comprising:
assigning a pivot angle by which the rotation axis is pivoted with respect to an initial position to the object images or data obtained from the latter based on images of the markings that are contained in the object images.

14. The method as claimed in claim 1, further comprising:
providing two cameras arranged in an offset manner; and
recording object images by the two cameras.

15. A panoramic scanner for a three-dimensional detection of an object, comprising:
a projector configured for projecting a pattern onto the object to be detected;
a camera configured for detecting object images;
a rotator configured for rotating the object relative to the projector and the camera having a position relative to the object that remains the same during the rotation, images of the markings being present in the object images, configured so that it is possible to combine object images generated at different angles of rotation of the object relative to the projector and the camera, or data obtained from these object images, based on the images of the markings that are present in the object images, to form a three-dimensional object model.

16. The panoramic scanner as claimed in claim 15, wherein the scanner is configured to determine, from the images of the markings, the spatial position of the object relative to at least one of the projector and the camera.

17. The panoramic scanner as claimed in claim 16, further comprising:
a rotary stage controller upon which the object is mounted during a scan.

18. The panoramic scanner as claimed in claim 17, wherein the markings are arranged on the rotary stage controller.

19. The panoramic scanner as claimed in claim 15, wherein the image of a plurality of markings is present in each object image.

20. The panoramic scanner as claimed in claim 15, further comprising:
a rotary stage controller upon which the object is mounted during a scan;
a drive unit for the rotary stage controller; and
a common housing configured to house the projector, the camera, the rotary stage controller and the drive unit for the rotary stage controller in a compact structural unit.

21. The panoramic scanner as claimed in claim 15, further comprising:
a pivot mechanism configured for pivoting a rotation axis of the object relative to the projector and the camera.

22. The panoramic scanner as claimed in claim 21, wherein the scanner is configured to determine a pivot angle by which the rotation axis is pivoted with respect to an initial position from the images of the markings.

23. The panoramic scanner as claimed in claim 21, further comprising:
an automatic pivoting mechanism for the rotation axis.

24. The panoramic scanner as claimed in claim 21, further comprising:
a pivot mount for the rotary stage controller for the purpose of pivoting the rotation axis.

25. The panoramic scanner as claimed in claim 24, further comprising:
a drive for the rotary stage controller for the automatic pivoting of the rotation axis.

26. The panoramic scanner as claimed in claim 25, further comprising:
a drive mechanism for the rotation and for the pivoting of the rotary stage controller with a single motor.

27. The panoramic scanner as claimed in claim 15, wherein the camera is a first camera, the scanner further comprising:
a second camera configured for detecting object images from a different direction from the first camera.

28. The panoramic scanner as claimed in claim 27, wherein the projector is a first projector, the scanner further comprising:
a second projector configured for projecting two-dimensional patterns from a different direction from the first projector onto the object to be detected.

29. The method according to claim 1, further comprising:
creating a three-dimensional model of an ear impression; and
utilizing the ear impression model as the object to be detected.

30. The panoramic scanner as claimed in claim 15, wherein the object to be detected is a three-dimensional model of an ear impression.
